(19) United States
(12) Patent Application Publication
(10) Pub. No.: US 2016/0264449 A1
(43) Pub. Date: Sep. 15, 2016

(54) Glass-Only Cutter Wheel

(71) Applicant: Toyo Industrial Co., Ltd., Osaka-shi (JP)

(72) Inventor: Asako Arai, Osaka-shi (JP)

(21) Appl. No.: 14/726,217

(22) Filed: May 29, 2015

(30) Foreign Application Priority Data
Mar. 10, 2015 (JP) 2015-046828

(51) Int. Cl. C03B 33/10

(52) U.S. Cl. CPC C03B 33/107

(57) ABSTRACT

A glass-only cutter wheel capable of eliminating the need for cleaning the glass after cutting and reducing rotation failures of the glass-only cutter wheel has a glass-only cutter wheel main body, a mounting hole provided along an axial center of the glass-only cutter wheel main body, one or a plurality of through holes and/or recessed holes provided to the glass-only cutter wheel main body along a circumferential direction of the mounting hole, and a liquefaction-resistant lubricant filled within the through hole(s) and/or recessed hole(s).

### FIELD OF THE INVENTION

The present invention relates to a glass-only cutter wheel used in cutting various types of glass such as glass for building construction, glass for vehicles such as automobiles, glass for electronic parts, glass for flat panel displays, etc.

### BACKGROUND OF THE INVENTION

Cutting oils are used in conventional glass cutting to provide good rotation of the glass-only cutter wheel or to suppress generation of glass chips during the cutting (see Patent Documents 1 and 2, for example).

However, use of the cutting oils as above makes the glass-only cutter wheel and a glass surface become soaked in oil. Therefore, a glass cleaning process after the glass cutting is disadvantageously required.

Meanwhile, a glass-only cutter wheel having an inner diameter formed into an odd shape is known in glass cutting for electronic parts and flat panel displays where the cutting oils cannot be used, in order to maintain good rotation of the glass-only cutter wheel (see Patent Document 3, for example).

However, even with the glass-only cutter wheel as above, there is a problem that abrasion powder generated by friction between a mounting hole of the glass-only cutter wheel and a rotary shaft inserted therein may be clogged to cause a rotation failure.

Further, there is another problem that when a holder groove and a side circumferential surface of the glass-only cutter wheel come into contact, frictional resistance caused by the contact cannot be reduced and consequently the rotation failure of the glass-only cutter wheel during the glass cutting cannot be reduced.

Accordingly, in order to solve such problems, an invention is proposed that a lubricating oil is filled within the mounting hole of the glass-only cutter wheel and two support shafts fixed to a cutter head are fitted into the mounting hole from both sides to reduce the rotation failure (see Patent Document 4).

### PRIOR ART DOCUMENTS

### Patent Documents

[Patent Document 1] Japanese Published Unexamined Utility Model Application No. S53-77958

[Patent Document 2] Japanese Published Unexamined Utility Model Application No. H6-6434

[Patent Document 3] Japanese Published Unexamined Patent Application No. 2000-53436

[Patent Document 4] Japanese Published Unexamined Patent Application No. 2003-137575

### SUMMARY OF THE INVENTION

### Problem to be Solved by the Invention

However, the cutter wheel as above has a problem that, although the rotation failure can be reduced temporarily, the lubricating oil filled within the mounting hole and the support shafts strongly rub against each other, as a result of which the lubricating oil leaks out of the mounting hole over time and the glass-only cutter wheel and the glass surface become soaked in oil, and thus the glass cleaning process after the glass cutting is required.

In view of the foregoing problem, the present invention aims at providing a glass-only cutter wheel capable of eliminating the need for the glass cleaning process after the glass cutting and reducing the rotation failure of the glass-only cutter wheel.

### Means for Solving the Problems

The above object of the present invention is achieved by the following means. It is noted that numerals in parentheses are reference numerals of embodiments described later but the present invention should not be restricted thereto.

According to the first aspect of the present invention, the glass-only cutter wheel is characterized by

a glass-only cutter wheel main body (10, 10A),

a mounting hole (12) provided along an axial center of the glass-only cutter wheel main body (10, 10A),

one or a plurality of through holes (13, 13A) and/or recessed holes (13a, 13A) provided to the glass-only cutter wheel main body (10, 10A) so as to be along a circumferential direction of the mounting hole (12), and

a liquefaction-resistant lubricant (14) filled within the through hole(s) (13, 13A) and/or recessed hole(s) (13a, 13A).

On the other hand, according to the second aspect of the present invention, the glass-only cutter wheel is characterized by

a glass-only cutter wheel main body (10B-10F);

a mounting hole (12) provided along an axial center of the glass-only cutter wheel main body (10B-10F);

one or a plurality of through holes (13B-13F) and/or recessed holes (13Ba, 13C-13F) provided to the glass-only cutter wheel main body (10B-10F) in positions at predetermined distances from the mounting hole (12), and

a liquefaction-resistant lubricant (14) filled within the through hole(s) (13B-13F) and/or recessed hole(s) (13Ba, 13C-13F).

Further, according to the third aspect of the present invention, the glass-only cutter wheel described in the foregoing first or second aspect is characterized in that the lubricant (14) has heat resistance.

### Effects of the Invention

Next, effects of the present invention will be described by giving reference numerals of the drawings. It is noted that numerals in parentheses are reference numerals of embodiments described later but the present invention should not be restricted thereto.

According to the first aspect of the present invention, one or a plurality of through holes (13, 13A) and/or recessed holes (13a, 13A) filled with the lubricant (14) are provided along the circumferential direction of the mounting hole (12), so that the lubricant (14) filled within the through hole(s) (13, 13A) and/or recessed hole(s) (13a, 13A) and the rotary shaft (3) come into contact and the lubricant (14) adheres to the rotary shaft (3), wherewith the frictional resistance between the rotary shaft (3) and the mounting hole (12) is reduced, even if the rotary shaft (3) and the mounting hole (12) come into contact to cause friction therebetween. As a result, the rotation failure of the glass-only cutter wheel can be reduced. With the reduction in the rotation failure like this, the generation of chips during cutting of the glass can be reduced. Additionally, there is no occurrence that the durability of the glass-only cutter wheel itself varies greatly among cutter wheels, and the durability is stabilized. Therefore, this can contribute to an improvement in yield of the cutting process. In particular, management is facilitated in use in an automated line, etc., and considerable labor-saving is possible. Further, the lubricant (14) is not filled within the mounting hole (12) which is a place that strongly rubs against the rotary shaft (3), and is filled in other places. In addition, the lubricant (14) resistant to liquefaction is used. Therefore, the need for the glass cleaning process after the glass cutting can be eliminated.

According to the second aspect of the present invention, one or a plurality of through holes (13B-13F) and/or recessed holes (13Ba, 13C-13F) filled with the lubricant (14) are provided in positions at predetermined distances from the mounting hole (12), so that the lubricant (14) filled within the through hole(s) (13B-13F) and/or recessed hole(s) (13Ba, 13C-13F) and left and right both side wall surfaces (22b) formed on a groove portion (22a) of a wheel holder lower portion (22) come into contact and the lubricant (14) adheres to the left and right both side wall surfaces (22b), wherewith the frictional resistance between a side circumferential surface (10Ba) of the glass-only cutter wheel main body and the left and right both side wall surfaces (22b) formed on the groove portion (22a) of the wheel holder lower portion (22) can be reduced, even if the side circumferential surface (10Ba) of the glass-only cutter wheel main body comes into contact with the left and right both side wall surfaces (22b) thereby to cause friction. As a result, the rotation failure of the glass-only cutter wheel can be reduced. With the reduction in the rotation failure like this, the generation of chips during cutting of the glass can be reduced. Additionally, there is no occurrence that the durability of the glass-only cutter wheel itself varies greatly among cutter wheels, and the durability is stabilized. Therefore, this can contribute to an improvement in yield of the cutting process. In particular, management is facilitated in use in an automated line, etc., and considerable labor-saving is possible. Further, the lubricant (14) is not filled within the mounting hole (12) which is a place that strongly rubs against the rotary shaft (3), and is filled in other places. In addition, the lubricant (14) resistant to liquefaction is used. Therefore, the need for the glass cleaning process after the glass cutting can be eliminated.

On the other hand, according to the third aspect of the present invention, the lubricant (14) has heat resistance, so that the lubricant (14) is resistant to liquefaction even if the glass temperature is high. Thus, the lubricant (14) is adaptive even under working conditions at high temperature such as a glass molding line.

### BRIEF DESCRIPTION OF THE DRAWINGS

FIG. 1A is a front view showing a state in which a glass-only cutter wheel according to the first embodiment of the present invention is rotatably attached to a wheel holder;

FIG. 1B is an enlarged view of a part A shown in FIG. 1A;

FIG. 2A is a side view of the glass-only cutter wheel according to the same embodiment;

FIG. 2B is a sectional view taken along line X-X of FIG. 2A;

FIG. 2C is a sectional view in which through holes according to the same embodiment are changed in design to recessed holes;

FIG. 3 is a side view of a glass-only cutter wheel according to the second embodiment of the present invention;

FIG. 4A is a side view of a glass-only cutter wheel according to the third embodiment of the present invention;

FIG. 4B is a sectional view taken along line Y-Y of FIG. 4A;

FIG. 4C is a sectional view in which through holes according to the same embodiment are changed in design to recessed holes;

FIG. 5 is a side view of a glass-only cutter wheel according to another embodiment of the present invention;

FIG. 6 is a side view of a glass-only cutter wheel according to another embodiment of the present invention;

FIG. 7 is a side view of a glass-only cutter wheel according to another embodiment of the present invention;

FIG. 8 is a side view of a glass-only cutter wheel according to another embodiment of the present invention; and

FIG. 9 is a graph showing results of glass cutting durability comparison made by using 15 pieces of the glass-only cutter wheels according to the first embodiment and conventional glass-only cutter wheels, each.

### DETAILED DESCRIPTION OF THE INVENTION

### Modes for Carrying Out the Invention

### First Embodiment

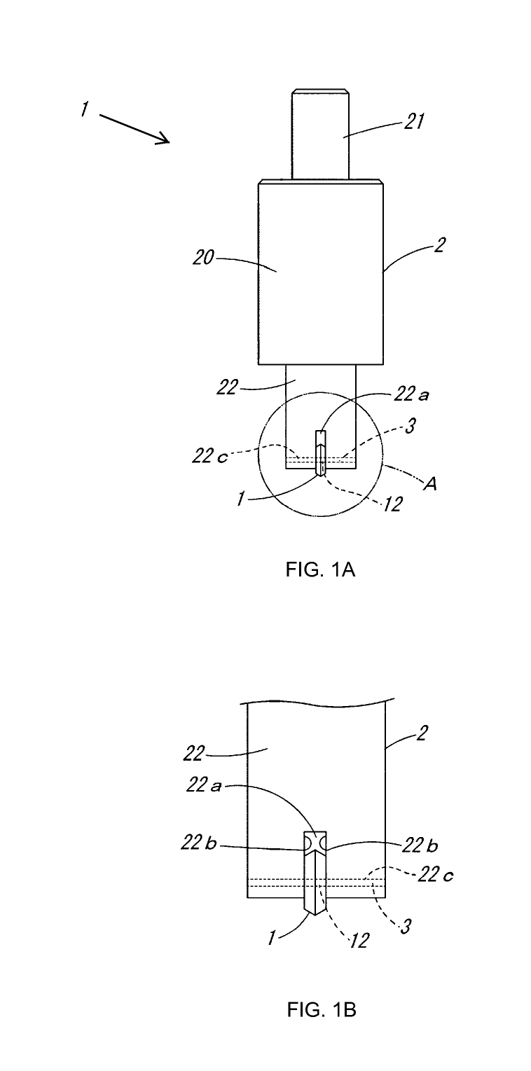

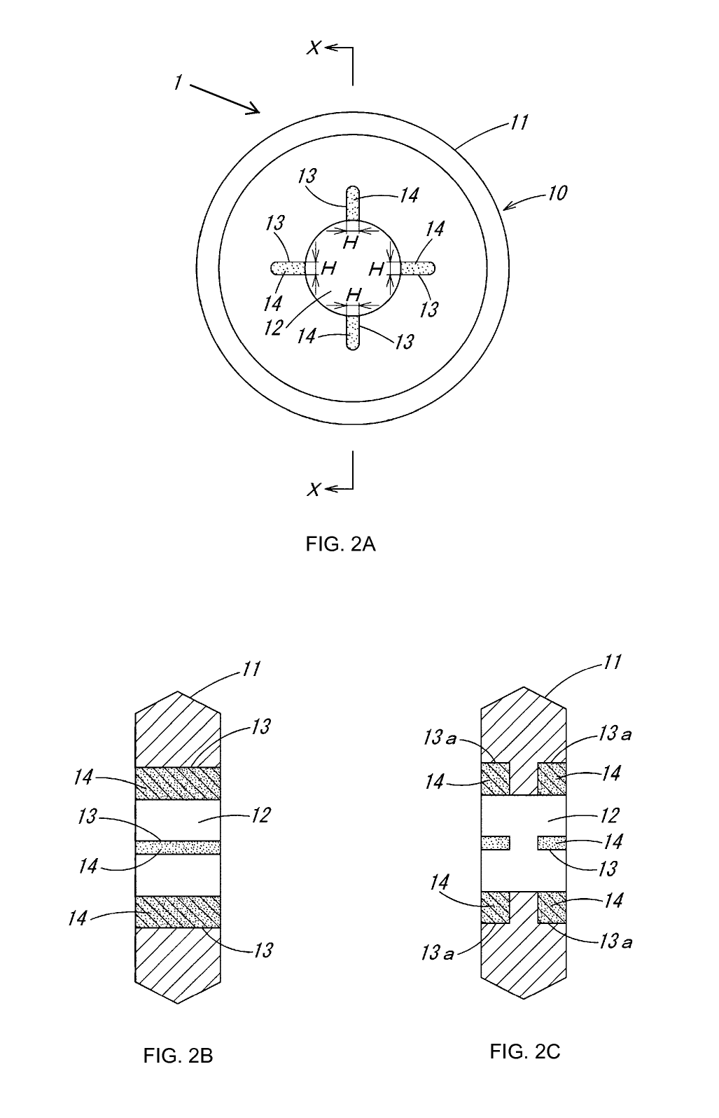

Hereinafter, the first embodiment of the glass-only cutter wheel according to the present invention will be described in detail with reference to FIGS. 1 to 2. When indicating up-down and left-right directions in the description below, they refer to those when viewed from the front shown in the drawings.

As shown in FIG. 1, a glass-only cutter wheel 1 according to the present embodiment is rotatably attached to a wheel holder 2. The wheel holder 2 is formed mainly of a material such as hardened steel, and is composed of a wheel holder central portion 20 formed in a substantially cylindrical shape, a substantially cylindrical wheel holder upper portion 21 protruded from an upper end portion of the wheel holder central portion 20 and having a diameter smaller than the wheel holder central portion 20, and a substantially cylindrical wheel holder lower portion 22 protruded from a lower end portion of the wheel holder central portion 20 and having a diameter smaller than the wheel holder central portion 20 as shown in FIG. 1A.

The wheel holder lower portion 22 has a lower end portion formed with a groove portion 22a capable of storing the glass-only cutter wheel 1 and having a U shape in a front view as shown in FIG. 1 (in particular, in FIG. 1B). A circular rotary shaft insertion hole 22c penetrates left and right both side wall surfaces 22b formed on the groove portion 22a, from a direction orthogonal to the left and right both side wall surfaces 22b toward the groove portion 22a side. To the thus penetrating rotary shaft insertion hole 22c, a rotary shaft 3 is inserted. To the inserted rotary shaft 3, the glass-only cutter wheel 1 is rotatably attached. By this, the glass-only cutter wheel 1 is rotatably stored within the groove portion 22a, and resultingly, the glass-only cutter wheel 1 is rotatably attached to the wheel holder 2. In inserting the rotary shaft 3 into the rotary shaft insertion hole 22c, the wheel holder 2 and the glass-only cutter wheel 1 may be integrated by press-fittingly inserting and crimping the rotary shaft 3.

On the other hand, the glass-only cutter wheel 1 is formed of a high hardness material such as cemented carbide or diamond single crystal. The glass-only cutter wheel 1 formed of such material includes a disc-shaped glass-only cutter wheel main body 10 having a V-shaped blade 11 forming a ridge along an outer circumferential portion as shown in FIGS. 2A and 2B. The glass-only cutter wheel main body 10 has an axial center through which a circular mounting hole 12 penetrates (see especially FIG. 2A). As shown in FIG. 2A, a plurality (four in the drawing) of vertically long semi-oval through holes 13 penetrate the glass-only cutter wheel main body 10, contacting with the circumference of the circular mounting hole 12 and spaced at predetermined intervals along the circumferential direction (see FIG. 2B). In penetratingly providing the through holes 13, any method may be employed. Since the glass-only cutter wheel 1 is formed of a high hardness material, the through holes 13 can be penetrated by electrical discharge wire cutting.

Meanwhile, a lubricant 14 resistant to liquefaction is filled within such through holes 13 as shown in FIGS. 2A and 2B. This lubricant 14 is composed of a mixture of wax, silicon, or grease, etc., and is formed to be slightly elastic and have a certain degree of stiffness so as not to be liquefied and leak out of the through holes 13. The lubricant 14 is also formed to have heat resistance so as not to be liquefied even under working conditions at high temperature. The length in a width direction H (see FIG. 2A) of the through hole 13 varies with the value of the diameter of the mounting hole 12, but about 0.01 mm to 1.6 mm is preferred. The number of the through holes 13 is preferably about 1 to 20 where the outer diameter of the glass-only cutter wheel main body 10 is 1.5 mm to 6 mm.

The thus formed glass-only cutter wheel 1 is stored within the groove portion 22a of the wheel holder 2 such that the rotary shaft insertion hole 22c of the wheel holder 2 and the mounting hole 12 of the glass-only cutter wheel 1 become coaxial. In this state, the rotary shaft 3 is inserted into the rotary shaft insertion hole 22c of the wheel holder 2 and into the mounting hole 12 of the glass-only cutter wheel 1, wherewith the glass-only cutter wheel 1 is rotatably stored within the groove portion 22a of the wheel holder 2.

In the glass-only cutter wheel 1 thus rotatably attached to the wheel holder 2, the wheel holder 2 is attached to a not-shown glass cutting device. Accordingly, as a result of the glass-only cutter wheel 1 rotating about the rotary shaft 3, the glass is cut (scribed) by the V-shaped blade 11 forming the ridge along the outer circumferential portion. At that moment, the rotary shaft 3 and the mounting hole 12 of the glass-only cutter wheel 1 come into contact and generate friction. However, the lubricant 14 filled in the through holes 13 contacting with the circumference of the mounting hole 12 and penetrated at predetermined intervals along the circumferential direction, and the rotary shaft 3 come into contact, and then the lubricant 14 adheres to the rotary shaft 3. Therefore, the frictional resistance between the rotary shaft 3 and the mounting hole 12 of the glass-only cutter wheel 1 is reduced. As a result, the rotation failure of the glass-only cutter wheel can be reduced. With the reduction in rotation failure like this, the generation of chips during cutting of the glass can be reduced. Additionally, there is no occurrence that the durability of the glass-only cutter wheel itself varies greatly among cutter wheels, and the durability is stabilized. Thus, this can contribute to an improvement in yield of the cutting process. In particular, management is facilitated in use in an automated line, etc., and considerable labor-saving is possible.

The lubricant 14 is formed to be slightly elastic and have a certain degree of stiffness so as to resist liquefaction, that is, not to be liquefied and leak out of the through holes 13. Further, the lubricant 14 is not filled within the mounting hole 12 which is a place that strongly rubs against the rotary shaft 3, and is filled in other places. Therefore, the need for the glass cleaning process after the glass cutting can be eliminated. Since having heat resistance, the lubricant 14 is resistant to liquefaction even if the temperature of the glass is high. Thus, the lubricant 14 is adaptive even under working conditions at high temperature such as a glass molding line.

The example that penetratingly provides the through holes 13 and the lubricant 14 is filled therein is given in the present embodiment. However, instead of penetration, recessed holes 13a may be provided as shown in FIG. 2C and the lubricant 14 may be filled therein. With such a configuration as well, the rotary shaft 3 and the lubricant 14 come into contact, and resultingly the frictional resistance between the rotary shaft 3 and the mounting hole 12 of the glass-only cutter wheel 1 can be reduced.

### Second Embodiment

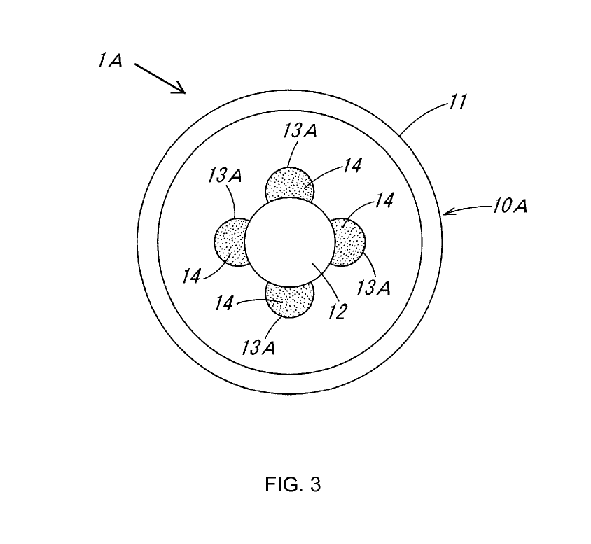

Next, the second embodiment of the glass-only cutter wheel according to the present invention will be described with reference to FIG. 3. The same configurations as those of the first embodiment are given the same reference numerals and their descriptions are omitted.

How the second embodiment differs from the first embodiment is only in the shape of the through holes 13 or recessed holes 13a, and all other components and configurations are the same. That is, as shown in FIG. 3, a glass-only cutter wheel 1A of the present embodiment is formed of a high hardness material such as cemented carbide or diamond single crystal. Further, the glass-only cutter wheel 1A includes a disc-shaped glass-only cutter wheel main body 10A having a V-shaped blade 11 forming a ridge along an outer circumferential portion. The glass-only cutter wheel main body 10A has an axial center through which a circular mounting hole 12 penetrates. The mounting hole 12 has its circumference provided with a plurality (four in the drawing) of substantially semicircular through holes or recessed holes 13A, contacting with the circumference of the mounting hole 12 and penetrated at predetermined intervals along the circumferential direction. A lubricant 14 is filled within the through holes or recessed holes 13A.

In this way as well, the rotary shaft 3 and the lubricant 14 come into contact and the lubricant 14 adheres to the rotary shaft 3. Thus, the frictional resistance between the rotary shaft 3 and the mounting hole 12 of the glass-only cutter wheel 1A can be reduced.

The example that provides a plurality of through holes 13, 13A or recessed holes 13a, 13A is given in the first and second embodiments. However, instead of providing the plurality of holes, a single hole may be provided. Further, the through holes and the recessed holes may be provided in combination, for example, some are the through holes and the rest are the recessed holes, without making all of them into the through holes or the recessed holes. Further, the shape of the through holes and/or recessed holes is not limited to the one shown in the first and second embodiments, and may be any shape as long as the rotary shaft 3 and the lubricant 14 can come into contact.

### Third Embodiment

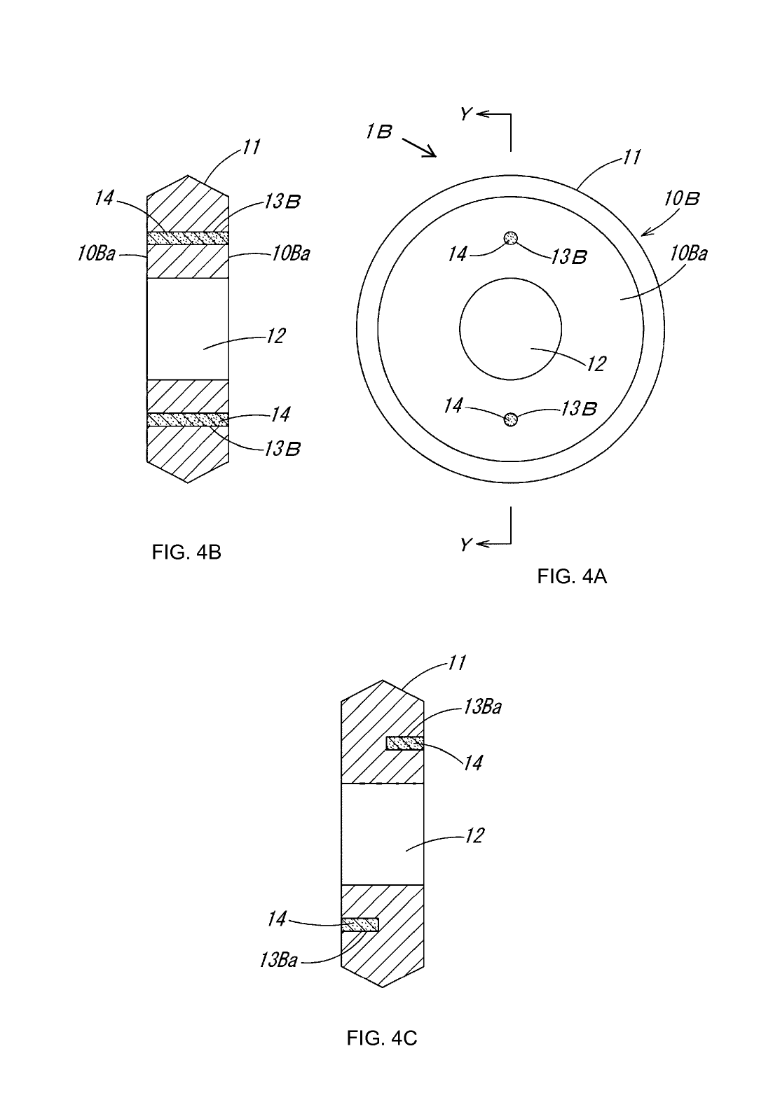

Next, the third embodiment of the glass-only cutter wheel according to the present invention will be described with reference to FIG. 4. The same configurations as those of the first and second embodiments are given the same reference numerals and their descriptions are omitted.

How the third embodiment differs from the first and second embodiments is only in the arrangement positions of the through holes and/or recessed holes, and all other components and configurations are the same. That is, as shown in FIG. 4A, a glass-only cutter wheel 1B of the present embodiment is formed of a high hardness material such as cemented carbide or diamond single crystal. Further, the glass-only cutter wheel 1B includes a disc-shaped glass-only cutter wheel main body 10B having a V-shaped blade 11 forming a ridge along an outer circumferential portion. The glass-only cutter wheel main body 10B has an axial center through which a circular mounting hole 12 penetrates. A plurality (two in the drawings) of through holes 13B having a diameter smaller than the mounting hole 12 (see FIG. 4B) are penetrated in positions at predetermined distances from the mounting hole 12. A lubricant 14 is filled within the through holes 13B.

Such glass-only cutter wheel 1B is rotatably attached to the wheel holder 2 (see FIG. 1) and this wheel holder 2 is attached to the not-shown glass cutting device, as a result of which the glass-only cutter wheel 1B rotates about the rotary shaft 3 and the glass is cut (scribed) by the V-shaped blade 11 forming the ridge along the outer circumferential portion. At that moment, friction is caused upon contact of a side circumferential surface 10Ba of the glass-only cutter wheel main body 10B (see FIGS. 4A and 4B) with the left and right both side wall surfaces 22b formed on the groove portion 22a of the wheel holder lower portion 22. However, the lubricant 14 filled within the through holes 13B and the left and right both side wall surfaces 22b come into contact, and the lubricant 14 adheres to the left and right both side wall surfaces 22b, wherewith the frictional resistance between the side circumferential surface 10Ba of the glass-only cutter wheel main body 10B and the left and right both side wall surfaces 22b formed on the groove portion 22a of the wheel holder lower portion 22 can be reduced. As a result, the rotation failure of the glass-only cutter wheel can be reduced. With the reduction in rotation failure like this, the generation of chips during cutting of the glass can be reduced. Additionally, there is no occurrence that the durability of the glass-only cutter wheel itself varies greatly among cutter wheels, and the durability is stabilized. Therefore, this can contribute to an improvement in yield of the cutting process. In particular, management is facilitated in use in an automated line, etc., and considerable labor-saving is possible.

The example that penetratingly provides the through holes 13B and the lubricant 14 is filled within the through holes 13B is shown in the present embodiment. However, instead of penetration, recessed holes 13Ba may be provided as shown in FIG. 4C and the lubricant 14 may be filled therein. With such a configuration as well, the left and right both side wall surfaces 22b and the lubricant 14 come into contact, and consequently the frictional resistance between the side circumferential surface 10Ba of the glass-only cutter wheel main body 10B and the left and right both side wall surfaces 22b formed on the groove portion 22a of the wheel holder lower portion 22 can be reduced.

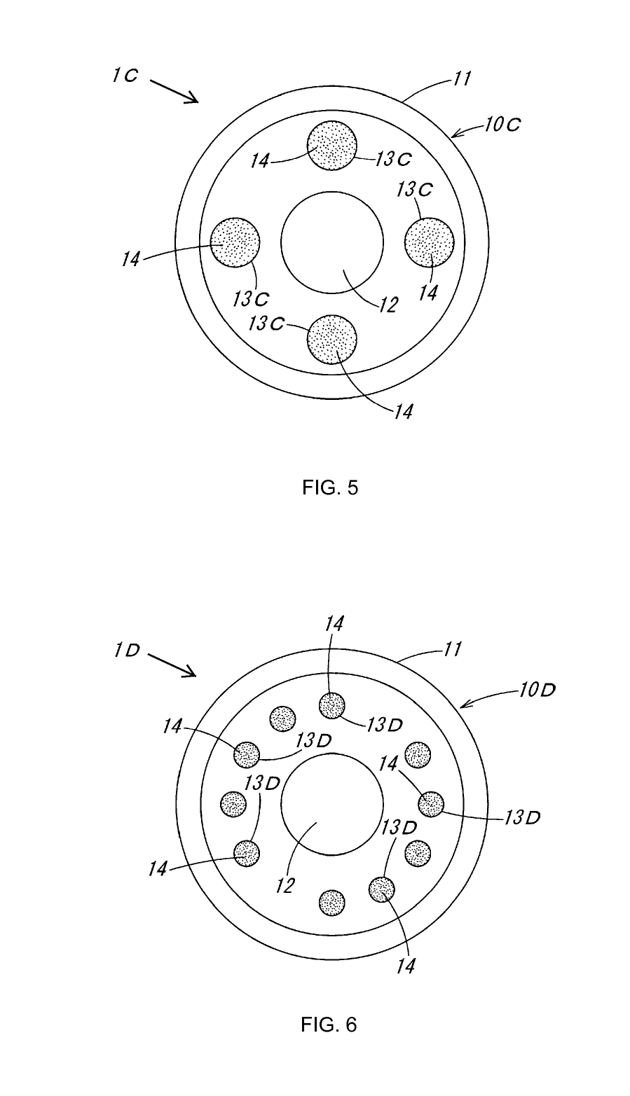

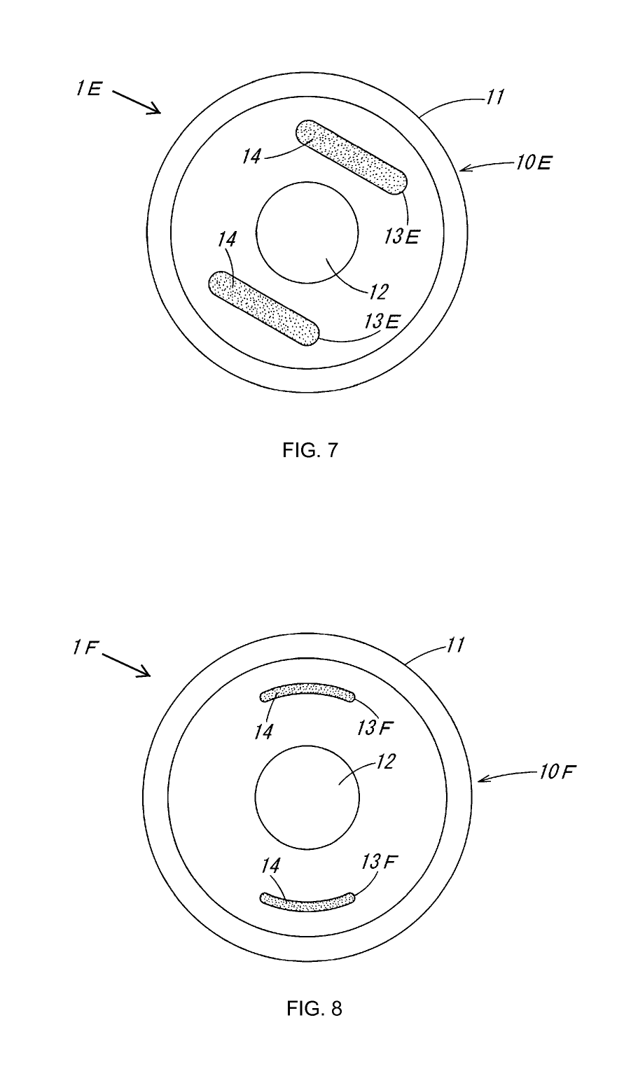

Meanwhile, the shape of the through holes 13B and/or recessed holes 13Ba shown in the third embodiment is merely an example, and may be any shape as long as the left and right both side wall surfaces 22b and the lubricant 14 come into contact. For example, as in a glass-only cutter wheel main body 10C of a glass-only cutter wheel 1C shown in FIG. 5, a plurality (four in the drawing) of circular through holes or recessed holes 13C may be provided at predetermined intervals so as to surround the mounting hole 12. Furthermore, as in a glass-only cutter wheel main body 10D of a glass-only cutter wheel 1D shown in FIG. 6, a plurality (ten in the drawing) of through holes or recessed holes 13D having a diameter smaller than the through holes or recessed holes 13C may be provided at predetermined intervals so as to surround the mounting hole 12. Still further, as in a glass-only cutter wheel main body 10E of a glass-only cutter wheel 1E shown in FIG. 7, a plurality (two in the drawing) of horizontally long oval through holes or recessed holes 13E may be provided. Furthermore, as in a glass-only cutter wheel main body 10F of a glass-only cutter wheel 1F shown in FIG. 8, a plurality (two in the drawing) of elongated arc-shaped through holes or recessed holes 13F may be provided.

In the same manner as that of the first and second embodiments, the through holes 13B, 13C, 13D, 13E, 13F or the recessed holes 13Ba, 13C, 13D, 13E, 13F may be one in number, instead of being provided plurally. Furthermore, the through holes and the recessed holes may be provided in combination, for example, some are the through holes and the rest are the recessed holes, without making all of them into the through holes or the recessed holes.

In the glass-only cutter wheels shown in the first to third embodiments, only the example has been shown that provides the through holes 13, 13A and/or the recessed holes 13a, 13A, contacting with the circumference of the mounting hole 12 and provided at predetermined intervals along the circumferential direction, or only the example has been shown that provides the through holes 13B, 13C, 13D, 13E, 13F and/or the recessed holes 13Ba, 13C, 13D, 13E, 13F in positions at predetermined distances from the mounting hole 12. However, they may be mixed. That is, the through holes 13, 13A and/or the recessed holes 13a, 13A may be provided, contacting with the circumference of the mounting hole 12 and provided along the circumferential direction, and also the through holes 13B, 13C, 13D, 13E, 13F and/or the recessed holes 13Ba, 13C, 13D, 13E, 13F may be provided in positions at predetermined distances from the mounting hole 12. With such a configuration, the rotation failure of the glass-only cutter wheel can be further reduced.

The example has been shown that the V-shaped blade 11 forming the ridge along the outer circumferential portion of the glass-only cutter wheels shown in the first to third embodiments has its distal end being a single step blade. However, the distal end is not limited thereto and may be a double step blade.

Furthermore, the glass-only cutter wheels shown in the first to third embodiments are not only used in the glass cutting device (not shown), but also, as a matter of course, can be applied to a glass cutter as a hand tool.

### Examples

Next, the present invention will be described in more detail, using examples.

15 pieces of the glass-only cutter wheels 1 according to the first embodiment and conventional glass-only cutter wheels each were used to make a glass cutting durability comparison.

As the size of the glass-only cutter wheels 1 and the conventional glass-only cutter wheels, those having an outer diameter of 2.5 mm, an inner diameter of 0.8 mm, a thickness of 0.65 mm, and a blade edge angle of 120° were used. The length in the width direction H of the through holes 13 of the glass-only cutter wheels 1 (see FIG. 2A) was set at 0.2 mm.

A non-alkali glass having a thickness of 0.7 mm was used as the glass. A test-only machine of Toyo Industrial Co., Ltd. was used as the glass cutting device. A difference between the glass-only cutter wheels 1 and the conventional glass-only cutter wheels was only in whether or not the through holes 13 filled with the lubricant 14 were provided on the circumference of the mounting hole 12, and all other components and configurations were the same.

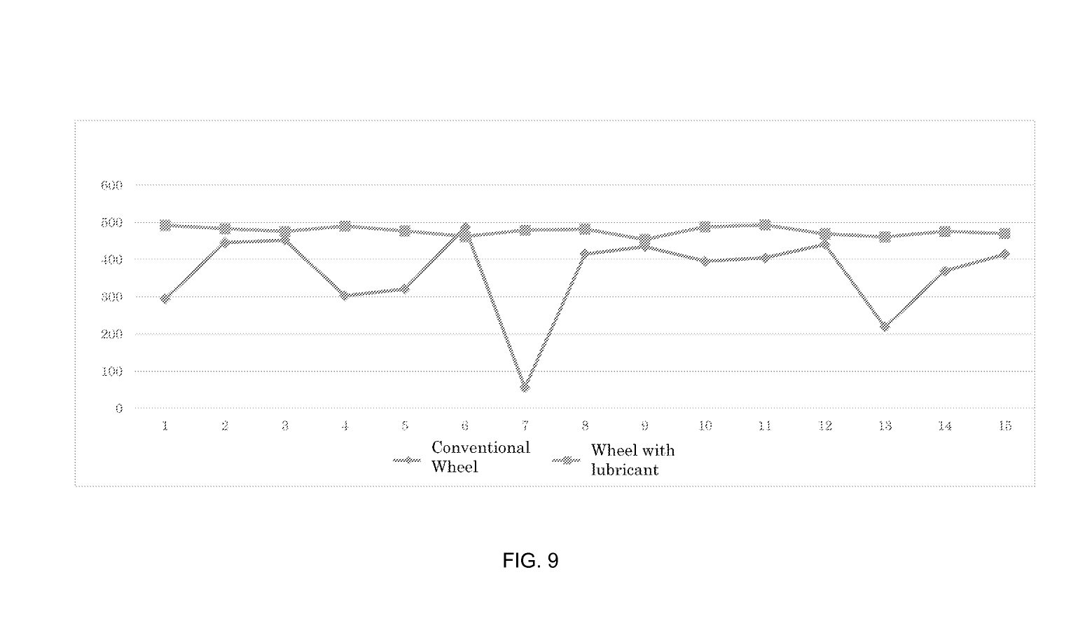

Under such conditions, the glasses continued to be cut by the glass-only cutter wheels until the breaking point of the glass-only cutter wheels was reached (until continuous generation of chips was seen and until crack failures continuously occurred) to measure the durability of the glass-only cutter wheels. The results are shown in the graph in FIG. 9.

The graph shown in FIG. 9 has the horizontal axis indicating what number glass-only cutter wheel 1 according to the first embodiment and conventional glass-only cutter wheel it is and the vertical axis indicating the number of times the glass was cut until the breaking point. That is, the first glass-only cutter wheel 1 according to the first embodiment reached the breaking point at about the 500th cutting, and the first conventional glass-only cutter wheel reached the breaking point at about the 290th cutting. The second glass-only cutter wheel 1 according to the first embodiment reached the breaking point at about the 490th cutting, and the second conventional glass-only cutter wheel reached the breaking point at about the 450th cutting. Further, the third glass-only cutter wheel 1 according to the first embodiment reached the breaking point at about the 480th cutting, and the third conventional glass-only cutter wheel reached the breaking point at about the 460th cutting. Further, the fourth glass-only cutter wheel 1 according to the first embodiment reached the breaking point at about the 490th cutting, and the fourth conventional glass-only cutter wheel reached the breaking point at about the 300th cutting. Like this, it is the graph shown in FIG. 9 that at what number of cutting times the 15 pieces of glass-only cutter wheels 1 according to the first embodiment and the 15 pieces of conventional glass-only cutter wheels respectively reached the breaking point are presented. “Conventional wheel” described in the graph shown in FIG. 9 denotes the conventional glass-only cutter wheel, and “Wheel with lubricant” denotes the glass-only cutter wheel 1 according to the first embodiment.

It is understood from this that each and every glass-only cutter wheel 1 according to the first embodiment reaches the breaking point at almost the same number of cutting times and the durability is stable. On the other hand, it is understood that the conventional glass-only cutter wheels exhibit a wide range of variations in the number of cutting times when reaching the breaking point depending on the piece and thus lack stability.

Then, it is understood that with the use of the glass-only cutter wheel according to the present embodiment, the glass cutting durability is stable as compared to the conventional glass-only cutter wheel. Therefore, according to the present embodiment, the glass-only cutter wheel can contribute to an improvement in yield of the glass cutting process, and in particular, management is facilitated in use in an automated line, etc., and considerable labor-saving is possible.

From the glass cutting durability being stable as compared to the conventional glass-only cutter wheel as above, it is understood that the rotation failure is reduced in the glass-only cutter wheel according to the present embodiment as compared to the conventional glass-only cutter wheel.

What is claimed is:

1. A glass-only cutter wheel comprising:
a glass-only cutter wheel main body;
a mounting hole provided along an axial center of the glass-only cutter wheel main body;
one or a plurality of through holes and/or recessed holes provided to the glass-only cutter wheel main body so as to be along a circumferential direction of the mounting hole; and
a liquefaction-resistant lubricant filled within the through hole(s) and/or recessed hole(s).

2. A glass-only cutter wheel comprising:
a glass-only cutter wheel main body;
a mounting hole provided along an axial center of the glass-only cutter wheel main body;
one or a plurality of through holes and/or recessed holes provided to the glass-only cutter wheel main body in positions at predetermined distances from the mounting hole; and
a liquefaction-resistant lubricant filled within the through hole(s) and/or recessed hole(s).

3. The glass-only cutter wheel according to claim 1, wherein the lubricant has heat resistance.

4. The glass-only cutter wheel according to claim 2, wherein the lubricant has heat resistance.
